(19) United States
(12) Patent Application Publication
(10) Pub. No.: US 2026/0171327 A1
(43) Pub. Date: Jun. 18, 2026

(54) SOLID ELECTROLYTIC CAPACITOR

(71) Applicant: Panasonic Intellectual Property Management Co., Ltd., Osaka (JP)

(72) Inventors: TAKASHI KAWASAKI, Osaka (JP); YUKI UEDA, Osaka (JP); NOBUO SASHINAKA, Osaka (JP); HITOSHI ISHIMOTO, Hyogo (JP); MASAYUKI HOGIRI, Osaka (JP); KAZUYA YAMASAKI, Kyoto (JP)

(21) Appl. No.: 19/123,568

(22) PCT Filed: Oct. 20, 2023
(86) PCT No.: PCT/JP2023/038066

§ 371 Date: Apr. 23, 2025

(30) Foreign Application Priority Data
Nov. 28, 2022 (JP) 2022-189409

(51) Int. Cl. H01G 9/15; H01G 9/14

(52) U.S. Cl. CPC H01G 9/15; H01G 9/14

(57) ABSTRACT

A solid electrolytic capacitor includes a carbon layer covering at least a part of the solid electrolyte layer, and a silver particle layer covering at least a part of the carbon layer and containing silver particles. In a section of the solid electrolytic capacitor, an average value of ratio L2/L1 of a total length L2 of parts of silver particles in contact with an interface between the carbon layer and the silver particle layer to a length Li of the interface is defined as an average value X, and an average value of value L1/N obtained by dividing the length L1 of the interface by a number N of the silver particles in contact with the interface is defined as an average value Y (μm). At this time, a relationship of Y≤1.154X−0.238 (where 0.3≤X<1.0 and Y≤0.5 m) is satisfied.

### TECHNICAL FIELD

The present disclosure relates to a solid electrolytic capacitor.

### BACKGROUND

A typical solid electrolytic capacitor includes an anode body provided on its surface with a dielectric layer, a cathode part, and a solid electrolyte layer disposed between the anode body and the cathode part. Various cathode parts have been heretofore proposed.

PTL 1 (Unexamined Japanese Patent Publication No. 2006-013031) describes Claim 1 as “A solid electrolytic capacitor and a method for manufacturing the solid electrolytic capacitor that is acquired by the steps of: forming a dielectric film on a surface of a sintered body obtained by pressure-molding and sintering valve metal powder; forming a solid electrolyte layer on the dielectric film; further forming a graphite layer and a conductor layer; applying a conductive paste containing nano conductive particles as a first conductor layer after the graphite layer is formed; and applying a conductive paste containing conductive particles having a mean particle diameter of 1.0 μm or more as a second conductor layer to form a conductor layer”.

PTL 2 (Unexamined Japanese Patent Publication No. 2009-170897) describes Claim 1 as “A solid electrolytic capacitor comprising: an anode body; a dielectric layer provided on a surface of the anode body; a conductive polymer layer provided on the dielectric layer; and a cathode layer having a carbon layer provided on the conductive polymer layer and a silver layer provided on the carbon layer, the conductive polymer layer having a surface with irregularities, the surface being close to the cathode layer, and the silver layer including a first silver layer provided on the carbon layer covering the irregularities and mainly containing silver particles that are each a spherical shape, and a second silver layer provided on the first silver layer and mainly containing silver particles that are each a plate shape”.

PTL 3 (Japanese Patent No. 5252421) describes Claim 1 as “A solid electrolytic capacitor comprising: a capacitor element in which a solid electrolyte layer, a carbon layer, and a conductor layer are sequentially formed on a dielectric film formed on a surface of a sintered body obtained by molding and sintering a valve metal powder; a cathode terminal connected the solid electrolytic capacitor with a conductive adhesive interposed therebetween; a nano conductor layer formed of only conductive nanoparticles in at least one interface of an interface between the solid electrolyte layer and the carbon layer, an interface between the carbon layer and the conductor layer, and an interface between the conductor layer and the conductive adhesive, the nano conductor layer being a deposited nano conductor layer in which conductive nanoparticles having a mean particle diameter of 1 nm to 50 nm are deposited; and a conductive coating film formed along the nano conductor layer and holding the conductive nanoparticles constituting the deposited nanoconductor layer”.

Patent Document 4 (Japanese Patent No. 4670402) describes Claim 1 as “A method for manufacturing a solid electrolytic capacitor, the method comprising: forming a dielectric oxide film and a solid electrolyte layer on a surface of an anode body made of a valve metal; and forming a cathode layer composed of a carbon layer and a silver layer on a surface of the solid electrolyte layer, wherein the silver layer is formed in which a paste of silver nanoparticles is prepared by mixing spherical silver nanoparticles, a dispersant, and an organic solvent to form a mixture, and mixing an organic binder into the mixture in which a dispersion liquid of the silver nanoparticles is dispersed in an organic solvent, and a silver paste is applied to the carbon layer and cured, the silver paste being formed by mixing silver particles having a mean particle diameter ratio of 100 times to 2500 times with respect to the silver nanoparticles into the paste of silver nanoparticles”.

### CITATION LIST

### Patent Literature

PTL 1: Unexamined Japanese Patent Publication No. 2006-013031
PTL 2: Unexamined Japanese Patent Publication No. 2009-170897
PTL 3: Japanese Patent No. 5252421
PTL 4: Japanese Patent No. 4670402

### SUMMARY

An aspect of the present disclosure relates to a solid electrolytic capacitor. The solid electrolytic capacitor includes an anode body, a dielectric layer disposed on a surface of the anode body, a solid electrolyte layer covering at least a part of the dielectric layer, a carbon layer covering at least a part of the solid electrolyte layer, and a silver particle layer covering at least a part of the carbon layer and containing silver particles. A relationship of Y≤1.154X−0.238 (where 0.3≤X<1.0, and Y≤0.5 μm) is satisfied, where in a section of the solid electrolytic capacitor, an average value X is an average value of ratio L2/L1 of a total length L2 of parts of the silver particles in contact with an interface between the carbon layer and the silver particle layer to a length L1 of the interface, and in the section of the solid electrolytic capacitor, an average value Y (μm) is an average value of value L1/N obtained by dividing the length L1 of the interface by a number N of the silver particles in contact with the interface.

According to the present disclosure, a solid electrolytic capacitor with low equivalent series resistance (ESR) is obtained.

### BRIEF DESCRIPTION OF THE DRAWINGS

FIG. 1 is a graph for explaining a configuration of a solid electrolytic capacitor according to the present disclosure.

FIG. 2 is a sectional view schematically illustrating an example of a solid electrolytic capacitor according to a first exemplary embodiment.

FIG. 3 is a diagram for explaining a method for evaluating a solid electrolytic capacitor.

### DESCRIPTION OF EMBODIMENT

A solid electrolytic capacitor is required to be reduced in equivalent series resistance (ESR) as further improvement of characteristics. In such a situation, the present disclosure provides a solid electrolytic capacitor having low ESR.

Although exemplary embodiments according to the present disclosure will be described below with reference to examples, the present disclosure is not limited to the examples described below. Although specific numerical values and materials may be provided as examples in the description below, another numerical value and another material may be applied as long as effect of the present disclosure can be obtained. The description, “numerical value A to numerical value B”, herein includes numerical value A and numerical value B, and can be read as “from numerical value A to numerical value B inclusive”. When lower limits and an upper limits of a numerical value related to a specific physical property, a condition, or the like are exemplified in the description below, any of the exemplified lower limits and any of the exemplified upper limits can be appropriately combined unless the lower limit is equal to or more than the upper limit. When examples of a component or examples of a method are listed in the description below, only one of the listed examples may be used, or a plurality of the listed examples may be used in combination, unless otherwise specified.

### (Solid Electrolytic Capacitor)

Hereinafter, a solid electrolytic capacitor according to the present exemplary embodiment may be referred to as “solid electrolytic capacitor (S)”. “Solid electrolytic capacitor (S)” includes an anode body, a dielectric layer disposed on a surface of the anode body, a solid electrolyte layer covering at least a part of the dielectric layer, a carbon layer covering at least a part of the solid electrolyte layer, and a silver particle layer covering at least a part of the carbon layer and containing silver particles. In a section of the solid electrolytic capacitor, an average value of ratio L2/L1 of a total length L2 of parts of the silver particles in contact with an interface between the carbon layer and the silver particle layer to a length L1 of the interface is defined as average value X. In the section of the solid electrolytic capacitor, an average value of value L1/N obtained by dividing the length L1 of the interface by a number N of the silver particles in contact with the interface is defined as average value Y (μm). At this time, a relationship of Y≤1.154X−0.238 (where 0.3≤X<1.0 and Y≤0.5 μm) is satisfied.

Average value X represents an average (average contact ratio) of ratios of parts of the interface, the parts being in contact with the silver particles. Average value Y represents an average interval (average contact interval) of the silver particles in contact with the interface. Hereinafter, three examples (first to third solid electrolytic capacitors) of solid electrolytic capacitor (S) will be described.

### (First to Third Solid Electrolytic Capacitors)

The first solid electrolytic capacitor has average value X of 0.64 or more, and average value Y of 0.5 μm or less. The second solid electrolytic capacitor has average value X of 0.50 or more, and average value Y of 0.3 μm or less. The third capacitor has average value X of 0.38 or more, and average value Y of 0.2 μm or less.

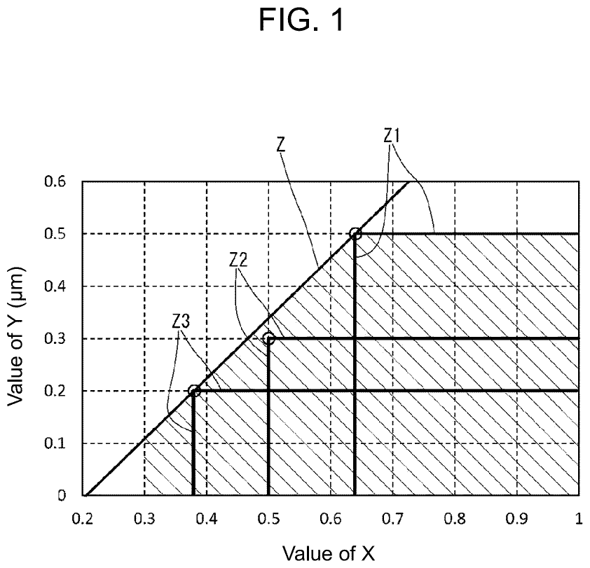

FIG. 1 illustrates ranges of the relationships described above. FIG. 1 is a graph showing straight line Z indicated by “Y=1.154X−0.238”. A region indicated by “Y≤1.154X−0.238 (where 0.3≤X<1.0 and Y≤0.5 μm) is a lower right region below straight line Z, indicated by hatching. Each of average value X and average value Y of the first solid electrolytic capacitor has a range that is a lower right region below line Z1 in the graph of FIG. 1. Each of average value X and average value Y of the second solid electrolytic capacitor has a range that is a lower right region below line Z2 in the graph of FIG. 1. Each of average value X and average value Y of the third solid electrolytic capacitor has a range that is a lower right region below line Z3 in the graph of FIG. 1.

To order to reduce interface resistance between the carbon layer and the silver particle layer, it is important to increase contact area between the carbon layer and the silver particles at the interface. For this purpose, using silver particles small in a particle diameter is conceivable. However, use of the silver particles each having a small particle diameter brings a problem of increasing cost.

As a result of consideration, the inventors of the present application have newly found that not only the contact area but also an average contact interval (average value Y) greatly affects the interface resistance. The inventors of the present application have further newly found that ESR can be reduced by reducing the average contact interval (average value Y), even with an equal contact area. The present disclosure is based on this new finding.

Although the reason why the ESR can be reduced by the above configuration is not clear at present, the reason is conceivable as follows. The carbon layer has higher resistance than the silver particles. Hence, as the average contact interval (average value Y) increases, a current does not sufficiently spread in the carbon layer even with a large contact area. Thus, since a part with no current flowing is generated even in the carbon layer, the ESR increases as a result. Solid electrolytic capacitor (S) according to the present disclosure enables low ESR to be achieved at low cost due to no requirement of use of silver particles smaller than necessary.

by increasing average value Y (average contact interval) of solid electrolytic capacitor (S), formation cost of the silver particle layer can particularly be reduced. For example, average value Y may be 0.05 μm or more, or 0.1 μm or more. Each of solid electrolytic capacitor (S) and the first to third solid electrolytic capacitors may have average value Y of 0.2 μm or more, or 0.3 μm or more as long as average value Y is not equal to or more than an upper limit value of average value Y of corresponding one of the capacitors. As average value Y decreases, the ESR tends to further decrease. Each of solid electrolytic capacitor (S) and the first to third solid electrolytic capacitors may have average value Y of 0.4 μm or less, or 0.3 μm or less as long as average value Y is equal to or less than the upper limit value of average value Y of the corresponding one of the capacitors.

By increasing average value X (average contact ratio) of solid electrolytic capacitor (S), the ESR can be particularly reduced. In contrast, by decreasing average value X, a binder and the like can be increased, and thus facilitating forming and maintaining the silver particle layer. Average value X is less than 1.0, and may be 0.9 or less, or 0.8 or less. Each of solid electrolytic capacitor (S) and the first to third solid electrolytic capacitors may have average value X of 0.64 or less, or 0.50 or less as long as average value X is not equal to or less than a lower limit value of average value X of corresponding one of the capacitors. Each of solid electrolytic capacitor (S) and the first to third solid electrolytic capacitors may have average value X of 0.38 or more, 0.50 or more, or 0.64 or more as long as average value X is not equal to or less than the lower limit value of average value X of the corresponding one of the capacitors.

A method for measuring average value X and average value Y will be described in Examples. Average value X and average value Y can be varied by varying at least one of a content ratio of silver particles in the silver particle layer and particle size distribution (e.g., a mean particle diameter) of the silver particles. For example, as the content ratio of the silver particles is increased and/or the mean particle diameter of the silver particles is reduced, average value X tends to increase. As the mean particle diameter of the silver particles is reduced, average value Y tends to decrease. Additionally, by mixing and using a plurality of sets of silver particles, which have mean particle diameters different from each other, average value Y can be reduced without greatly varying a mean particle diameter of the entire silver particles.

### (Carbon Layer)

The carbon layer of solid electrolytic capacitor (S) will be described below. The carbon layer contains a carbonaceous material (carbonaceous material having conductivity) and has conductivity. The carbonaceous material is not particularly limited. Examples of the carbonaceous material include graphite, carbon black, graphene pieces, and carbon nanotubes. The carbon layer may contain only one kind of carbonaceous material or may contain a plurality of kinds of carbonaceous materials. The carbon layer may have a thickness in a range from 0.2 μm to 20 μm, inclusive (e.g., in a range from 1 μm to 3 μm, inclusive).

A content ratio of the carbonaceous material in the carbon layer may be 50 mass % or more, 70 mass % or more, or 80 mass % or more, and 100 mass % or less. The content ratio may be 50 vol % or more, 70 vol % or more, or 80 mass % or more, and 100 vol % or less.

The carbon layer may contain a binder and/or an additive agent as necessary, for example. The binder and the additive agent are not particularly limited, and a binder and an additive agent used for a carbon layer of a known solid electrolytic capacitor may be used. Examples of the binder include resins such as thermoplastic resins (polyester resin and the like) and thermosetting resins (polyimide resin, epoxy resin, etc.). Examples of the additive agent include dispersants, surfactants, antioxidants, preservatives, bases, and acids.

A method for forming the carbon layer is not particularly limited, and a known method for forming a carbon layer of a solid electrolytic capacitor may be used. The carbon layer is formed according to procedure below in one example of the method for forming the carbon layer. First, a paste (carbon paste) containing particles of the carbonaceous material and a dispersion medium is formed. Then, components (a binder, an additive agent, etc.) other than the carbonaceous material are added to the carbon paste as necessary. As the dispersion medium, water, an organic medium, or a mixture thereof is used.

Next, a coating film is formed by applying the carbon paste covering at least a part of the solid electrolyte layer. The carbon paste may be applied by immersing the anode body provided with the solid electrolyte layer into the carbon paste, or may be applied by another method. Subsequently, the coating film (carbon paste) is dried to remove the dispersion medium. The carbon layer is formed in this way. A method for drying the coating film is not limited, and a known drying method may be used. For example, the coating film may be dried by heating.

### (Silver Particle Layer)

The silver particle layer of solid electrolytic capacitor (S) will be described below. The silver particle layer contains silver particles and has conductivity. A thickness of the silver particle layer may be in a range from 5 μm to 100 μm, inclusive (e.g., in a range from m to 60 μm, inclusive).

The silver particles constituting the silver particle layer may have a particle size distribution (e.g., based on volume) including only one peak in the particle size distribution. The silver particle layer may contain a plurality of sets of silver particles, which have mean particle diameters different from each other. In this case, particle size distribution (e.g., based on volume) of the silver particles may include a plurality of peaks. For example, the silver particles contained in the silver particle layer may include first silver particles having a mean particle diameter in a range from 0.05 μm to 1.5 μm, inclusive (e.g., in a range from 0.1 m to 1.0 μm, inclusive) and second silver particles having a mean particle diameter in a range from 2.0 μm to 10 μm, inclusive (e.g., in a range from 2.0 μm to 5.0 μm, inclusive), or may be composed of these silver particles. In this case, particle size distribution (e.g., based on volume) of the silver particles may include a peak in a range from 0.05 μm to 1.5 μm, inclusive (e.g., in a range from 0.1 μm to 1.0 μm, inclusive) and a peak in a range from 2.0 μm to 10 μm, inclusive (e.g., in a range from 2.0 μm to 5.0 μm, inclusive). A value of (mass of first silver particles)/(mass of second silver particles) in the silver particle layer may be in a range from 0.1 to 0.9, inclusive.

The mean particle diameter of the silver particles is a median diameter (D50) at which a cumulative volume is 50% in particle size distribution based on volume. The mean particle diameter (median diameter) is determined using a laser diffraction and scattering particle size distribution measurement apparatus. When the mean particle diameter of the silver particles in the silver particle layer of the solid electrolytic capacitor is measured, the mean particle diameter may be measured using the silver particles taken out from the silver particle layer.

The silver particle layer may contain a binder and/or an additive agent as necessary. The binder and the additive agent are not particularly limited, and a binder and an additive agent used for a silver particle layer of a known solid electrolytic capacitor may be used. Examples of the binder include resins such as thermoplastic resins (polyester resin and the like) and thermosetting resins (phenol resin, polyimide resin, epoxy resin, etc.). Examples of the additive agent include dispersants, surfactants, antioxidants, preservatives, bases, and acids.

A method for forming the silver particle layer is not particularly limited, and a known method for forming a silver particle layer of a solid electrolytic capacitor may be used. The silver particle layer is formed according to procedure below in one example of the method for forming the silver particle layer. First, a paste (silver paste) containing silver particles and a dispersion medium is formed. Then, components (a binder, an additive agent, etc.) other than the silver particles are added to the silver paste as necessary. As the dispersion medium, water, an organic medium, or a mixture thereof is used.

Next, by applying the silver paste covering at least a part of the solid electrolyte layer, a coating film is formed. The silver paste may be applied by immersing the anode body provided with the solid electrolyte layer into the silver paste, or may be applied by another method. Subsequently, the coating film (silver paste) is dried to remove the dispersion medium. The silver particle layer is formed in this way. A method for drying the coating film is not limited, and a known drying method may be used. For example, the coating film may be dried by heating.

Configurations other than the carbon layer and the silver particle layer are not particularly limited. For components other than the carbon layer and the silver particle layer, components used in known solid electrolytic capacitors may be applied, for example. Although examples of components of the solid electrolytic capacitor of the present disclosure will be described below, a configuration of solid electrolytic capacitor (S) according to the present disclosure is not limited to the configuration exemplified below.

Solid electrolytic capacitor (S) includes at least one capacitor element, and may include a plurality of capacitor elements. The capacitor element includes an anode body (anode part), a dielectric layer, and a cathode part. The cathode part includes a solid electrolyte layer and a cathode lead-out layer. The cathode lead-out layer includes the carbon layer and the silver particle layer that are described above.

### (Anode Part)

The solid electrolytic capacitor includes an anode part, and the anode part includes an anode body. The anode part may be composed of only the anode body or may include another component. The anode body is made of a predetermined metal (e.g., a valve metal or an alloy containing a valve metal). Examples of the valve metal include titanium (Ti), tantalum (Ta), niobium (Nb), and aluminum (Al).

The anode body may be a porous sintered body. The anode part may include the porous sintered body (anode body) and an anode wire. The anode wire includes a part embedded in the porous sintered body, and other parts protruding from the porous sintered body. The porous sintered body is formed by sintering particles to be a material. Examples of the particles to be a material include particles of the predetermined metal (e.g., titanium, tantalum, and niobium). Only one kind of particles, or a mixture of two or more kinds of particles may be used for the particles.

The anode wire may be made of metal. Examples of the material of the anode wire include the valve metal described above, copper, aluminum, and aluminum alloy. The anode wire includes a part embedded in the anode body, and a remaining part protruding from the anode body. The anode wire has a rod shape. The anode wire protruding from the anode body may have a distal end with a sectional shape different from that of another part.

The anode body composed of the porous sintered body may be produced by the following method. First, the anode wire is partially embedded in metal powder as a material of the anode body, and the metal powder is molded into a columnar shape (e.g., a rectangular parallelepiped shape) by compression molding. After that, the metal powder is sintered to form an anode body composed of a porous sintered body. In this way, the anode body in which the anode wire is partially embedded can be produced. Sintering enables forming a porous anode body.

The anode body may be metal foil of the predetermined metal or aluminum foil. When metal foil is used for the anode body, the metal foil (e.g., etching foil) provided on its surface with a porous part is typically used.

### (Dielectric Layer)

The dielectric layer is formed on at least a part of the surface of the anode body. The dielectric layer and a method for forming the dielectric layer are not particularly limited. The dielectric layer may be formed by a known method. For example, the dielectric layer may be formed by immersing the anode body in an anodizing solution to anodize the surface of the anode body. Alternatively, the dielectric layer may be formed by heating the anode body in an atmosphere containing oxygen to oxidize the surface of the anode body. When the anode body includes a porous part on the surface, the dielectric layer is formed on a surface of the porous part.

### (Solid Electrolyte Layer)

The solid electrolyte layer and a method for forming the solid electrolyte layer are not particularly limited, and a solid electrolyte layer used in a known solid electrolytic capacitor and a method for forming the solid electrolyte layer may be used. The solid electrolyte layer may be a stacked body of two or more different electrolyte layers.

The solid electrolyte layer is disposed covering at least a part of the dielectric layer. The solid electrolyte layer may be made of a conductive polymer. Examples of the conductive polymer include polypyrrole, polythiophene, polyaniline, and derivatives thereof. These polymers may be each used alone or a combination of a plurality of kinds of the polymers may be used. The conductive polymer also may be a copolymer of two or more kinds of monomers. The derivative of the conductive polymer means a polymer having the conductive polymer as a basic skeleton. Examples of the derivative of polythiophene include a poly (3,4-ethylenedioxythiophene).

The conductive polymer may contain a dopant added. The dopant can be selected depending on the conductive polymer, and a known dopant may be used. Examples of the dopant include naphthalenesulfonic acid, p-toluenesulfonic acid, polystyrenesulfonic acid, and salts thereof. One example of the solid electrolyte layer is formed using a poly (3,4-ethylenedioxythiophene) (PEDOT) doped with polystyrenesulfonic acid (PSS).

The solid electrolyte layer containing the conductive polymer may be formed by polymerizing a raw material monomer on the dielectric layer. Alternatively, the solid electrolyte layer may be formed by applying a liquid containing the conductive polymer (and the dopant as necessary) to the dielectric layer and then drying the liquid.

### (Cathode Lead-Out Layer)

The cathode lead-out layer includes the carbon layer and the silver particle layer that are stacked on the solid electrolyte layer. The carbon layer and the silver particle layer have been described above, and thus duplicated description is not described.

### (Lead Terminal)

Solid electrolytic capacitor (S) includes a lead terminal as necessary. An anode lead terminal is electrically connected to the anode body (anode part). A cathode lead terminal is electrically connected to the cathode lead-out layer.

### (Outer Packaging Resin)

At least a part of the capacitor element is covered with an outer packaging resin. As the outer packaging resin, a known outer packaging resin used for a solid electrolytic capacitor may be applied. For example, the outer packaging resin may be made of an insulating resin material used for sealing the capacitor element. The outer packaging resin may contain a substance (such as an inorganic filler) other than the resin.

One example of solid electrolytic capacitor (S) according to the present exemplary embodiment will be described with reference to the drawings. The one example is described below with components to which the components described above are applicable. The one example of the solid electrolytic capacitor described below can be changed based on the description described above. Matters described below may be applied to the exemplary embodiment described above.

### First Exemplary Embodiment

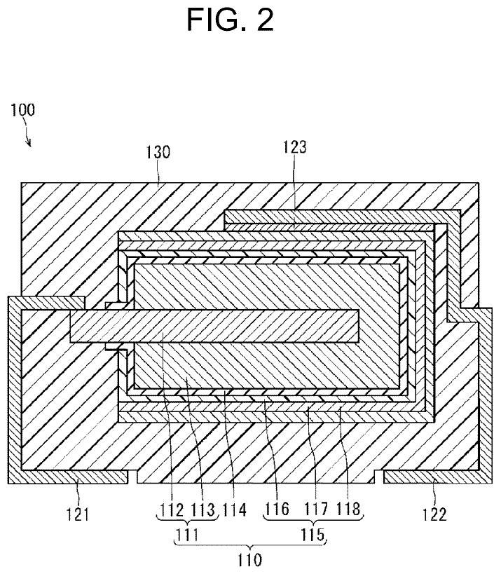

FIG. 2 is a sectional view schematically illustrating a solid electrolytic capacitor according to a first exemplary embodiment. Solid electrolytic capacitor 100 illustrated in FIG. 2 includes capacitor element 110, anode lead terminal 121, cathode lead terminal 122, conductive layer 123, and outer packaging resin 130. Conductive layer 123 is made of a silver paste or the like.

Capacitor element 110 includes anode part 111, dielectric layer 114, and cathode part 115. Anode part 111 includes anode wire 112 and anode body 113. The first exemplary embodiment shows an example in which anode body 113 is a porous sintered body. Anode wire 112 includes a part embedded in anode body 113, and other parts protruding from anode body 113. Anode lead terminal 121 is connected to anode wire 112. Anode lead terminal 121 is electrically connected to anode body 113 through anode wire 112.

Dielectric layer 114 is formed covering a part of anode wire 112 and anode body 113. Cathode part 115 includes solid electrolyte layer 116, carbon layer 117, and silver particle layer 118. Carbon layer 117 and silver particle layer 118 are the carbon layer and the silver particle layer described above, respectively. Cathode lead terminal 122 is connected to silver particle layer 118 with conductive layer 123 interposed therebetween.

That is, cathode lead terminal 122 is connected to cathode part 115 with conductive layer 123 interposed therebetween.

Techniques below are disclosed by the above description.

### (Technique 1)

A solid electrolytic capacitor includes:
an anode body;
a dielectric layer disposed on a surface of the anode body;
a solid electrolyte layer covering at least a part of the dielectric layer;
a carbon layer covering at least a part of the solid electrolyte layer; and
a silver particle layer covering at least a part of the carbon layer and containing silver particles.

A relationship of Y≤1.154X−0.238 (where 0.3≤X<1.0, and Y≤0.5 μm) is satisfied,
where in a section of the solid electrolytic capacitor, an average value X is an average value of ratio L2/L1 of a total length L2 of parts of the silver particles in contact with an interface between the carbon layer and the silver particle layer to a length L1 of the interface, and
in a section of the solid electrolytic capacitor, an average value Y (μm) is an average value of value L1/N obtained by dividing the length L1 of the interface by a number N of the silver particles in contact with the interface.

### (Technique 2)

The solid electrolytic capacitor described in Technique 1, in which average value X is 0.64 or more, and average value Y is 0.5 μm or less.

### (Technique 3)

The solid electrolytic capacitor described in Technique 1, in which average value X is 0.50 or more, and average value Y is 0.3 μm or less.

### (Technique 4)

The solid electrolytic capacitor described in Technique 1, in which average value X is 0.38 or more, and average value Y is 0.2 μm or less.

### EXAMPLES

The solid electrolytic capacitor according to the present disclosure will be described in more detail based on Example. This Example was evaluated in which a plurality of solid electrolytic capacitors having different average values X and Y was produced. Solid electrolytic capacitor (S) according to the present disclosure is not limited to Example below.

### (Capacitor A1-1-1)

Capacitor A1-1-1 (solid electrolytic capacitor) was produced according to procedure below.

### (1) Production of Porous Sintered Body

Tantalum powder was molded into a rectangular parallelepiped, and one end of an anode wire was embedded in the rectangular parallelepiped. Next, the molding body was sintered in vacuum. In this way, a porous sintered body (thallium sintered body) in which a part of the anode wire was embedded was obtained. A tantalum wire was used as the anode wire.

### (2) Formation of Dielectric Layer

The porous sintered body in which a part of the anode wire was embedded was subjected to an anodizing treatment (anodization) to form a dielectric layer (tantalum oxide layer) on a surface of the porous sintered body. In this way, an anode body provided on its surface with the dielectric layer was obtained.

### (3) Formation of Solid Electrolyte Layer

A solid electrolyte layer containing polypyrrole and a dopant was formed in pores of the porous sintered body (anode body) provided on its surface with the dielectric layer. As the dopant, a sulfonate having a naphthalene skeleton was used. The solid electrolyte layer was formed by electrolytic polymerization. The electrolytic polymerization was performed at 20° C. using a treatment solution containing pyrrole, the dopant, and water.

### (4) Formation of Cathode Lead-Out Layer

First, a carbon paste containing carbon particles and a dispersion medium was prepared. Next, the carbon paste was applied onto the solid electrolyte layer to form a coating film. Then, the coating film was heated to form a carbon layer on the solid electrolyte layer. Subsequently, a silver paste was formed on the carbon layer to form a coating film. As the silver paste, a silver paste containing silver particles, a binder, and a dispersion medium was used. As the silver particles, particles obtained by mixing small particles having a mean particle diameter of 0.3 μm and large particles having a mean particle diameter of 3 μm at a ratio (mass ratio) of 0.38:0.62 (the small particles:the large particles), were used. Then, a proportion of silver particles in a solid content of the silver paste was set to 94 mass %. Next, the formed coating film was heated to form a silver particle layer on the carbon layer. In this way, a capacitor element was obtained.

### (5) Production of Solid Electrolytic Capacitor

A conductive adhesive material to be a conductive layer was applied to the silver particle layer. Next, a cathode lead terminal and the silver particle layer were bonded using the conductive adhesive material. Then, the anode wire and the anode lead terminal were bonded by resistance welding. Subsequently, the capacitor element to which the cathode lead terminal and the anode lead terminal were bonded was sealed with outer packaging resin. In this way, capacitor A1-1-1 was obtained.

### (Other Capacitors)

Other solid electrolytic capacitors shown in Table 1 were produced under the same conditions and by the same method as in the production of capacitor A1-1-1 except that the silver paste for forming the silver particle layer was changed. Silver pastes used for the other capacitors each had a mean particle diameter of silver particles contained in the silver paste, a proportion of small particles in the silver particles, and a proportion of the silver particles in a solid content of the silver paste, which were changed as shown in Table 1. Any one of the silver pastes used silver particles containing small particles and large particles. The proportion of the silver particles in the solid content of the silver paste was equal to a proportion of the silver particles in the silver particle layer.

### (Evaluation)

Each produced capacitor was evaluated as follows.

### (1) Average Value X (Average Contact Ratio) and Average Value (Y) (Average Contact Interval)

For each produced capacitor, average value X and average value Y were acquired according to procedure below. First, a section of the produced capacitor was exposed by a cross section polisher method (CP method). Next, any five points including an interface between the carbon layer and the silver particle layer were selected from the exposed section, and sectional images at the five points were acquired using a scanning electron microscope (SEM). In this way, SEM images (magnification: 20,000 times) were acquired, in each of which the section in the image had a size of 6.3 μm×4.8 μm (area: 30.24 μm²). Each of the SEM images was analyzed as follows.

In the SEM image, line BS having a width of 50 nm centered at an interface between the carbon layer and the silver particle layer was drawn, and line BS served as the interface.

Then, a length of the line BS was measured. From the length of line BS and the magnification of the SEM image, length L1 (μm) of the interface in the section was determined.

Next, the number N of silver particles in contact with line BS (interface) was counted. From the obtained number N and length L1, value L1/N was calculated. Then, lengths of parts of the silver particles in contact with line BS were measured and summed. From the summed value and the magnification of the SEM image, total L2 (μm) of the lengths of the parts of the silver particles in contact with the interface (line BS) was determined. From determined length L1 and total L2, ratio L2/L1 thereof was calculated.

As described above, value L1/N and ratio L2/L1 were determined for each of the five SEM images. Then, average value (Y) (average contact interval) was obtained by arithmetically averaging five values L1/N. Similarly, average value X (average contact ratio) was obtained by arithmetically averaging five ratios L2/L1.

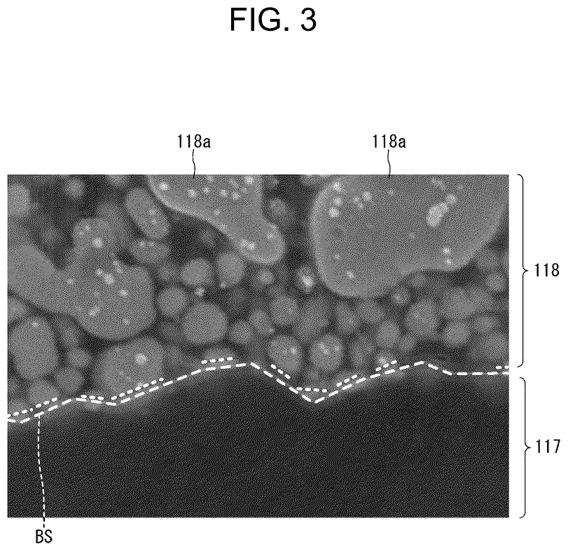

FIG. 3 shows a part of an example (magnification: 20,000 times) of the measured SEM image. FIG. 3 shows the center of line BS with a dotted line. FIG. 3 shows a part of the silver particles in contact with the interface (line BS) also with a dotted line.

### (2) Equivalent Series Resistance (ESR)

ESR was measured for each of the produced capacitors.

Table 1 shows a mean particle diameter of the silver particles used for forming the silver particle layer and an evaluation result of each capacitor. The “proportion of small particles” in Table 1 indicates a proportion (mass proportion) of small particles in the entire silver particles. For example, the silver paste used in capacitor A1-1-1 has a ratio (mass ratio) of 0.38:0.62 (small particles:large particles), and thus a proportion of the small particles in the entire silver particles is 0.38 (38 mass %). The “proportion of silver particles” in Table 1 indicates a proportion (mass proportion) of silver particles in a solid content of the silver paste. For example, the silver paste used in capacitor A1-1-1 has a proportion of 0.94 (94 mass %) of the silver particles in the solid content of the silver paste.

TABLE 1

| | | | Silver particles | | | | |
|---|---|---|---|---|---|---|---|
| | | | Mean particle | Mean particle | Proportion of | Proportion of | |
| | | Average | diameter of | diameter of | small particles | silver particles | |
| | Average | value Y | small particles | large particles | (mass | (mass | ESR |
| Capacitor | value X | (μm) | [um] | [um] | proportion) | proportion) | [mΩ] |
| C1-1 | 0.64 | 1.0 | 0.3 | 3 | 0.10 | 0.96 | 6.1 |
| C1-2 | 0.64 | 1.0 | 0.5 | 3 | 0.40 | 0.96 | 6.1 |
| C1-3 | 0.64 | 1.0 | 1 | 3 | 0.70 | 0.94 | 6.1 |
| A1-1-1 | 0.64 | 0.5 | 0.3 | 3 | 0.38 | 0.94 | 5.9 |
| A1-1-2 | 0.64 | 0.5 | 0.5 | 3 | 0.70 | 0.93 | 5.9 |
| A1-1-3 | 0.64 | 0.5 | 1 | 3 | 0.62 | 0.95 | 5.9 |
| A1-2 | 0.64 | 0.3 | 0.2 | 3 | 0.36 | 0.94 | 5.9 |
| A1-3 | 0.64 | 0.2 | 0.2 | 3 | 0.59 | 0.92 | 5.8 |
| A1-4 | 0.64 | 0.1 | 0.1 | 3 | 0.48 | 0.92 | 5.8 |
| C2 | 0.50 | 0.5 | 0.2 | 3 | 0.23 | 0.89 | 6.1 |
| A2-1 | 0.50 | 0.3 | 0.3 | 3 | 0.35 | 0.86 | 5.9 |
| A2-2 | 0.50 | 0.2 | 0.2 | 3 | 0.33 | 0.86 | 5.9 |
| A2-3 | 0.50 | 0.1 | 0.1 | 3 | 0.35 | 0.87 | 5.8 |
| C3 | 0.38 | 0.3 | 0.1 | 3 | 0.12 | 0.83 | 6.1 |
| A3-1 | 0.38 | 0.2 | 0.1 | 3 | 0.18 | 0.82 | 6.0 |
| A3-2 | 0.38 | 0.1 | 0.1 | 3 | 0.28 | 0.79 | 5.9 |

Capacitors A (A1-1-1 to A3-2) are each solid electrolytic capacitor (S) according to the present disclosure. Capacitors C (C1-1 to C3) are each a solid electrolytic capacitor of Comparative Example. As shown in Table 1, each capacitor A had a low ESR (6.0 mΩ or less). In contrast, each capacitor C of Comparative Example had a high ESR.

The present disclosure is applicable to a solid electrolytic capacitor.

1. A solid electrolytic capacitor comprising:
an anode body;
a dielectric layer disposed on a surface of the anode body;
a solid electrolyte layer covering at least a part of the dielectric layer;
a carbon layer covering at least a part of the solid electrolyte layer; and
a silver particle layer covering at least a part of the carbon layer, the silver particle layer containing silver particles,
wherein following relationships are satisfied,
Y≤1.154X−0.238,
0.3≤X<1.0, and
Y≤0.5 μm
where in a section of the solid electrolytic capacitor, an average value X is an average value of a ratio L2/L1 of a total length L2 of parts of the silver particles in contact with an interface between the carbon layer and the silver particle layer to a length L1 of the interface, and
in the section of the solid electrolytic capacitor, an average value Y (μm) is an average value of a value L1/N obtained by dividing the length L1 of the interface by a number N of the silver particles in contact with the interface.

2. The solid electrolytic capacitor according to claim 1, wherein:
the average value X is 0.64 or more, and
the average value Y is 0.5 μm or less.

3. The solid electrolytic capacitor according to claim 1, wherein:
the average value X is 0.50 or more, and
the average value Y is 0.3 μm or less.

4. The solid electrolytic capacitor according to claim 1, wherein:
the average value X is 0.38 or more, and
the average value Y is 0.2 μm or less.
